(19) United States
(12) Patent Application Publication
(10) Pub. No.: US 2015/0198729 A1
(43) Pub. Date: Jul. 16, 2015

(54) REGULARIZATION OF SPATIALLY ALIASED SEISMIC DATA

(71) Applicant: CGG SERVICES SA, Massy Cedex (FR)

(72) Inventors: Ping WANG, Sugar Land, TX (US); Kawin NIMSAILA, Houston, TX (US)

(21) Appl. No.: 14/593,297

(22) Filed: Jan. 9, 2015

Related U.S. Application Data
(60) Provisional application No. 61/926,699, filed on Jan. 13, 2014.

(51) Int. Cl. G01V 1/32

(52) U.S. Cl. CPC G01V 1/325; G01V 1/38

(57) ABSTRACT

Presented are methods and systems for regularizing seismic data. The method includes receiving the seismic data, transforming the seismic data into the tau-p domain and regularizing the seismic data to desired positions in the tau-p domain using at least one low rank sparse inversion.

### RELATED APPLICATION

The present application is related to, and claims priority from U.S. Provisional Patent Application No. 61/926,699, filed Jan. 13, 2014, entitled “FAST PROGRESSIVE SPARSE TAU-P TRANSFORM FOR REGULARIZATION OF SPATIALLY ALIASED SEISMIC DATA”, to Ping WANG and Kawin NIMSAILA, the entire disclosure of which is incorporated herein by reference.

### TECHNICAL FIELD

Embodiments of the subject matter disclosed herein generally relate to methods and systems for seismic data processing and, more particularly, to mechanisms and techniques for regularization of seismic data.

### BACKGROUND

Seismic data acquisition and processing techniques are used to generate a profile (image) of a geophysical structure (subsurface) of the strata underlying the land surface or seafloor. Among other things, seismic data acquisition involves the generation of acoustic waves and the collection of reflected/refracted versions of those acoustic waves to generate the image. This image does not necessarily provide an accurate location for oil and gas reservoirs, but it may suggest, to those trained in the field, the presence or absence of oil and/or gas reservoirs. Thus, providing an improved image of the subsurface in a shorter period of time is an ongoing process in the field of seismic surveying.

Mapping subsurface geology during exploration for oil, gas, and other minerals and fluids uses a form of remote sensing to construct two-dimensional or three-dimensional images of the subsurface. The process is known as seismic surveying.

Four-dimensional images can also be created by comparing two or more 3-D images acquired at different times to look for changes in the subsurface caused by for example gas injection or production.

Looking to FIG. 1, marine seismic data acquisition, as used, for example, for exploration, field development, and/or production monitoring (time lapse), is normally conducted by a tow vessel 102 towing long cables 104, 108, some of them with seismic sensors 106 through the water. These cables are known as “lead-ins” 104 and “streamers” 108 to people skilled in the art. The streamers 108 are equipped with a large number of seismic sensors 106 with which recordings are made from subsurface reflections of acoustic energy that originate from a seismic source 110 as, for example, a pressure source such as air guns, vibrators, etc. towed behind the seismic vessel 102. A towed array can include one or more streamers 108.

Each time a seismic source 110 is activated, it emits a seismic signal that travels downward through the earth, is reflected, and, upon its return, is received by the seismic sensors 106 in the streamer(s) 108. Each streamer 108 contains a plurality of seismic sensors 106 at spaced apart locations. The received signals are recorded by recording devices. Recorded signals from multiple seismic source 110 and seismic sensor 106 combinations are then processed, assembled and/or combined to create a nearly continuous profile of the subsurface that can extend for many miles. In a two-dimensional (2-D) marine seismic survey, the reflected signal is recorded by the seismic sensors 106 on a single streamer 108, whereas in a three-dimensional (3-D) survey a number of streamers 108 are used simultaneously. In simplest terms, a 2-D seismic line can be thought of as a vertical slice of the earth layers directly beneath the streamer 108. A 3-D survey produces a data “cube” or volume that is, at least conceptually, a 3-D picture of the subsurface that lies beneath the survey area. In reality, though, both 2-D and 3-D surveys interrogate some volume of earth lying beneath the area covered by the survey.

A seismic streamer 108 will typically be several kilometers long, and be comprised of several hundred sensors designed to pick up reflected waves from the subsurface. It is normally also equipped with compasses, acoustic pingers 112, depth sensors and other auxiliary units that give continuous location information about heading, position and depth. Furthermore, each streamer is typically equipped with attached units known as birds 114 that control the heading and depth of that streamer 108.

Chapter 1, pages 9-89, of “Seismic Data Processing” by Özdogan Yilmaz, Society of Exploration Geophysicists, 1987, contains general information relating to conventional 2-D processing and its disclosure is incorporated herein by reference. General background information pertaining to 3-D data acquisition and processing may be found in Chapter 6, pages 384-427, of Özdogan Yilmaz.

A seismic trace is usually a digital recording of the acoustic energy that is received or otherwise picked up by one or more seismic sensors 106. Typically, a trace is determined by combining a group of seismic sensors 106 over a certain length, in some examples referred to as a “receiver length” or “group length”. In some examples, a group of seismic sensors 106 is referred to as a “receiver”. In marine seismic, this group length is typically between 3.125 meters and 12.5 meters, but in some examples, a seismic trace can also be a recording of a received seismic signal from one single seismic sensor 106. In some examples, a “seismic sensor” 106 refers to a single seismic sensor 106 or a group of seismic sensors 106 in a streamer 108 (“receiver”).

In seismic acquisition, the location on the surface halfway between the center of the seismic source 110 and the center of the seismic sensor 106 is referred to as a common mid-point (CMP) and is typically shared by numerous pairs of seismic sources 110 and seismic sensors 106. The CMP location of every trace in a seismic survey is tracked and is generally made a part of the trace header information. This allows the seismic information contained within the traces to be later correlated with specific surface and subsurface locations, thereby providing a means for placing and displaying the trace in its correct position.

A problem often encountered during seismic acquisition is that data are sampled irregularly. The reason for this can be streamer 108 and/or source 110 feathering (i.e., when the streamer is not towed straight through the water due to ocean currents), obstructions that force the vessel 102 to deviate from the desired course and various mishaps result in missing data. This lack of regular sampling is especially problematic in the cross-line direction (perpendicular to the towing direction), where the data is less well sampled compared to the in-line direction.

Although seismic acquisition techniques are constantly evolving to deliver higher volume and more densely sampled data, they are still far from providing adequate and regularly sampled data along all spatial axes. It is well-known that key processes, such as 3D surface-related multiple attenuation (SRME) and 3D pre-stack migration, are more effective when input traces are evenly and densely sampled. Data regularization, which interpolates and extrapolates acquired seismic traces from their original irregular grid onto a regular grid, is an important process which is used to address this problem.

Over the last decade, many data regularization techniques have been developed to improve spatial sampling of input data prior to migration. For example, the Minimum Weighted Norm Interpolation (MWNI) method proposed by Liu and Sacchi in 2004 uses lower frequencies to guide the interpolation of higher frequencies. In 2005, Xu et al. introduced the Anti-Leakage Fourier Transform (ALFT) method, which iteratively builds the interpolated traces from strong to weak Fourier coefficients. In a similar approach, Abma and Kabir (2006) used the Projection onto Convex Sets (POCS) image-restoration algorithm, which works iteratively with either Fourier or Radon transforms.

Most of these regularization methods use a Fourier basis, which is orthogonal for regular grids. For irregular grids, ALFT was proposed to ensure the orthogonality of the Fourier basis. The tau-p transform (Hugonnet and Boelle, 2007) is less frequently used for data regularization for two reasons: the basis is not orthogonal, and the cost is very high. Nonetheless, it would be desirable to perform data regularization in the tau-p domain because irregular girds are better handled in the tau-p domain and the tau-p domain is a preferred domain for sparse inversion since the seismic data is generally sparse in tau-p domain and the sparse inversion in tau-p domain allows the handling of spatial aliasing associated with the acquired seismic data.

Accordingly, it would be desirable to provide systems and methods that avoid the afore-described problems and drawbacks associated with regularization of seismic data.

### SUMMARY

According to various embodiments herein, methods and systems are disclosed for regularizing and/or optimizing the collected (actual) seismic data using a data regularization algorithm that combines a sparse tau-p inversion scheme with low-rank optimization.

According to an embodiment, a method for regularizing seismic data includes the steps of receiving the seismic data, transforming the seismic data into the tau-p domain; and regularizing the seismic data to desired positions in the tau-p domain using at least one low rank sparse inversion.

According to another embodiment, a computing system for regularizing seismic data includes an interface for receiving the seismic data, and at least one processor connected to the interface and configured to transform the seismic data into the tau-p domain, and regularize the seismic data to desired positions in the tau-p domain using at least one low rank sparse inversion.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 depicts a marine seismic data acquisition system;

FIG. 2 depicts a method for regularizing seismic data according to an embodiment;

FIG. 3 is a flowchart illustrating one of the steps of the method of FIG. 2 in more detail according to an embodiment;

FIG. 4 shows sequential inversion performed on batches of seismic data of increasing frequency according to an embodiment;

FIG. 5 illustrates adding an external iteration to the sequential inversions of FIG. 4 according to another embodiment;

FIGS. 6(a)-6(c) are graphs of simulated seismic data at various stages of the application of a regularization technique in accordance with an embodiment; and

FIG. 7 depicts an exemplary data processing device or system which can be used to implement the embodiments.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. However, the embodiments to be discussed next are not limited to the configurations described in the drawings, but may be extended to other arrangements as discussed later.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to various embodiments herein, methods and systems are disclosed for regularizing and/or optimizing the collected (actual) seismic data using a data regularization algorithm that combines a sparse tau-p inversion scheme with low-rank optimization. Various embodiments also address one or more related issues, such as computational efficiency, aliasing, and/or weak events. Using 3D synthetic and field seismic data examples, it is demonstrated that the embodiments are effective for the regularization of strongly spatially-aliased seismic data while remaining cost-effective.

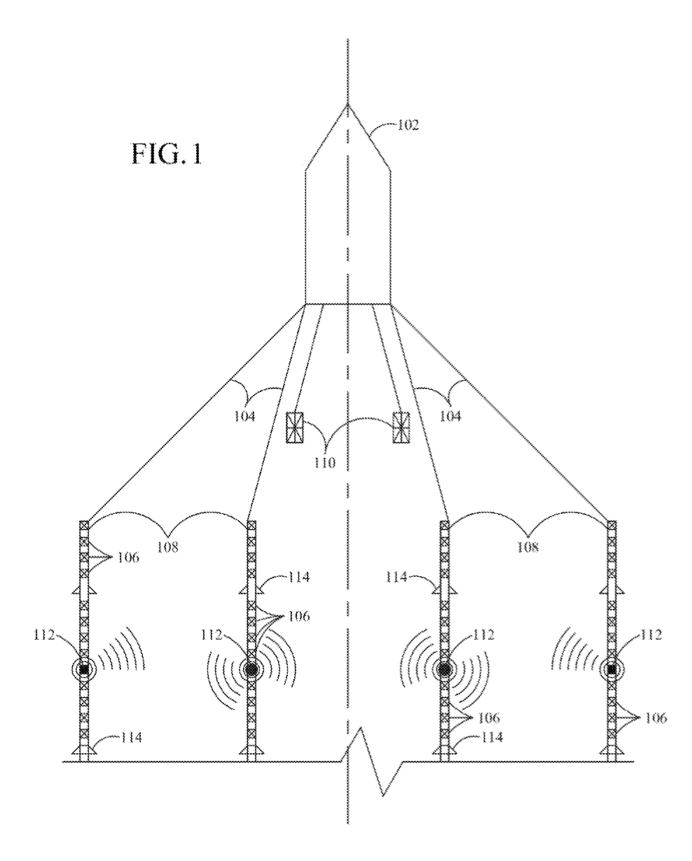

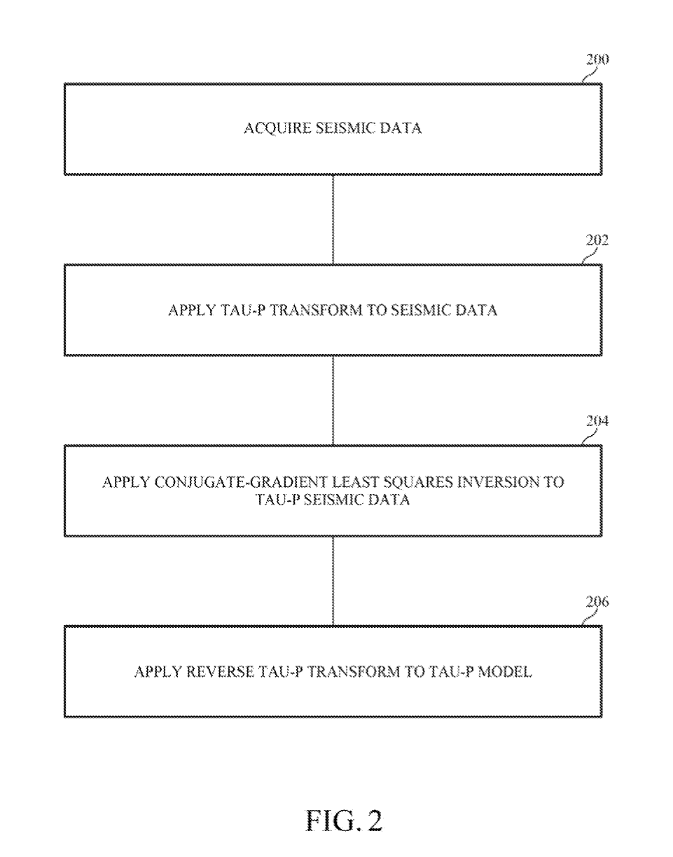

A method embodiment is illustrated in the flowchart of FIG. 2. Therein, at step 200, seismic data is acquired and input one or more processors to be regularized in accordance with the techniques to be described below. The seismic data can, for example, be acquired using the marine seismic data acquisition system described above with respect to FIG. 1, or any other seismic data acquisition system. For example, the seismic data may be acquired by other means, e.g., ocean bottom cables or autonomous underwater vehicles. Even for these alternative acquisition systems, there may be a desire to generate the new traces in between the positions of the seismic sensors that recorded the data.

Additionally, the seismic data referred to in step 200 may or may not be “raw” seismic data, i.e., previously unprocessed. As those skilled in the art will appreciate, seismic data processing typically involves the application of a number of data processing techniques including, but not limited to, filtering, migration, inversion and interpolation/regularization. Thus the techniques described herein may be applied at various points within the overall seismic data processing workflow, and the data referred to in step 200 may have had previous seismic data processing applied thereto or not.

At step 202, a tau-p transform is applied to the acquired seismic data. As will be appreciated by those skilled in the art the acquired (recorded) seismic data 200 is typically in the x-t domain. A high-resolution Radon transform is called a tau-p transform, where tau is the time-intercept and p is the slowness. There are variations of the tau-p transform that include linear, parabolic, hyperbolic, shifted hyperbolic, etc. The Radon transform may be solved either in the time- or frequency-domain in a mixture of dimensions, for example tau-pₓ-p_{y}-qₕ, where p relates to linear, q relates to parabolic and x, y, and h refer to the x-, y-, and offset-directions, respectively. This tau-p transform in step 202 can, for example, be performed as follows.

Assume that the acquired seismic data D can be expressed as a transformation of the model P through the operator A as:

D=AP (1)

In common-shot gathers, seismic data D can be expressed as a function of time t, offset x, and offset y: D=D(t,xᵢ,yᵢ). Here i=1, . . . , n, where n is the number of traces. Data D can be represented interchangeably in the time (t) or frequency (f) domain through the standard FFT. The model P is assumed to be a function of slowness \vec{p}ⱼ=(pₓ^{j},p_{y}^{j}):P=P(f,pₓ^{j},p_{y}^{j}), where j=1, . . . , m and m is the total number of slowness pairs. Using the Linear Radon transform, equation (1) can be written in matrix notation as follows:

$$\begin{matrix} ( \begin{matrix}D ( f , {x}_{1} , {y}_{1} ) \\ D ( f , {x}_{2} , {y}_{2} ) \\ ⋮ \\ D ( f , {x}_{n} , {y}_{n} )\end{matrix} ) = A ( \begin{matrix}P ( f , {p}_{x}^{1} , {p}_{y}^{1} ) \\ P ( f , {p}_{x}^{2} , {p}_{y}^{2} ) \\ ⋮ \\ P ( f , {p}_{x}^{m} , {p}_{y}^{m} )\end{matrix} ) \\ where & ( 2 ) \\ A = ( \begin{matrix}{e}^{- i 2 π f ( {p}_{x}^{1} {x}_{1} + {p}_{y}^{1} {y}_{1} )} & {e}^{- i 2 π f ( {p}_{x}^{2} {x}_{1} + {p}_{y}^{2} {y}_{1} )} & ⋮ & {e}^{- i 2 π f ( {p}_{x}^{m} {x}_{1} + {p}_{y}^{m} {y}_{1} )} \\ {e}^{- i 2 π f ( {p}_{x}^{1} {x}_{2} + {p}_{y}^{1} {y}_{2} )} & {e}^{- i 2 π f ( {p}_{x}^{2} {x}_{2} + {p}_{y}^{2} {y}_{2} )} & ⋮ & {e}^{- i 2 π f ( {p}_{x}^{m} {x}_{2} + {p}_{y}^{m} {y}_{2} )} \\ … & … & & … \\ {e}^{- i 2 π f ( {p}_{x}^{m} {x}_{n} + {p}_{y}^{m} {y}_{n} )} & {e}^{- i 2 π f ( {p}_{x}^{m} {x}_{n} + {p}_{y}^{m} {y}_{n} )} & ⋮ & {e}^{- i 2 π f ( {p}_{x}^{m} {x}_{n} + {p}_{y}^{m} {y}_{n} )}\end{matrix} ) . & ( 3 )\end{matrix}$$

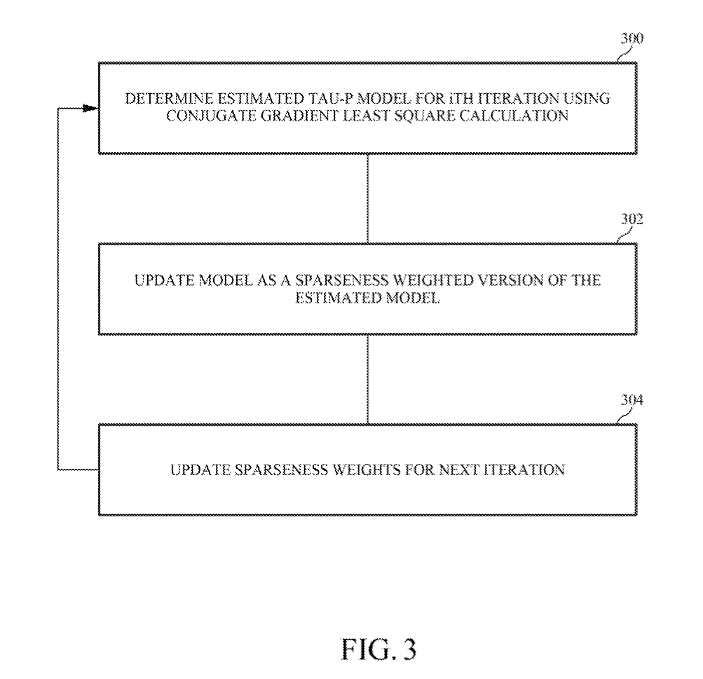

One result of calculating equation (2) using the acquired seismic data is that the input seismic data 200 is now in the frequency domain as the output of step 202. To regularize the data, it is thus desirable to perform a conjugate-gradient least-squares inversion to obtain an optimized (regularized) tau-p model of the seismic data as indicated by step 204. This step 204 can be performed iteratively using the method illustrated in the flow diagram of FIG. 3.

Therein, at step 300, and for each i^{th} iteration of the sparse tau-p inversion, the process operates to calculate the minimum least square as:

$${min}_{\tilde{M}} {‖ D - {AW}_{i} {\tilde{M}}_{i} ‖}^{2} \qquad ( 4 )$$

to identify an estimated tau-p model \tilde{M}ᵢ for that iteration. A conjugate gradient approach to determining the least square (i.e., a conjugate gradient least square can be employed as:

(AWᵢ)^{T}D=(AWᵢ)^{T}(AWᵢ)\tilde{M}ᵢ (5)

where Wᵢ is a sparseness weight for iteration i. The estimated Tau-P model \tilde{M}ᵢ is then used at step 302 to determine an actual model value Mᵢ for this iteration as a function of the estimated model \tilde{M}ᵢ and the sparseness weight Wᵢ as:

Mᵢ=Wᵢ\tilde{M}ᵢ (6)

At step 304, the sparseness weights are updated for the next iteration as:

Wᵢ₊₁(j,j)=∥\tilde{M}ᵢ(j)∥^{p} (7)

In order to address the challenges described above with respect to using the tau-p domain for regularization/interpolation is, as mentioned above, its basis is not orthogonal. As a result, using the tau-p domain requires a large p-range and small p-increment (i.e., the model space is large, especially for high dimensions) to represent the input data accurately. On the other hand, the input seismic data are often sparse (which is the reason that the seismic data needs to be interpolated in the first place). Due to the discrepancy between the large model space and the small data space, the inversion is typically prohibitively expensive and unstable/non-unique. Thus embodiments described herein provide for a low-rank optimization approach to reduce the model parameters. First, a full-rank inversion is performed over high-cut filtered seismic data using all p's, and then the most dominant (highest energy) p's are used for a low-rank, full-bandwidth inversion. By performing this low-rank optimization, the inversion process in the tau-p domain not only becomes stable, but the cost is also significantly reduced.

Once a final tau-p model is determined using the technique illustrated in FIGS. 2 and 3 in tandem with the afore-described low-rank optimization, then the tau-p model can be reverse transformed as indicated by step 206 to return the seismic data to the x-t domain.

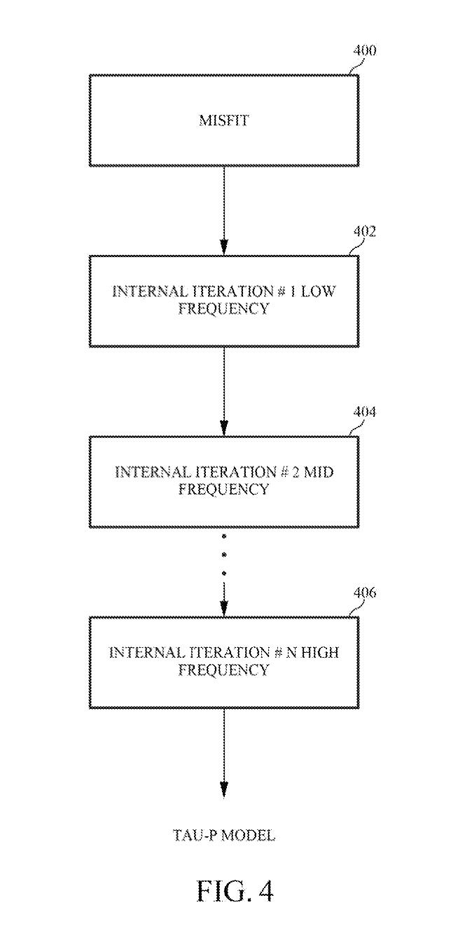

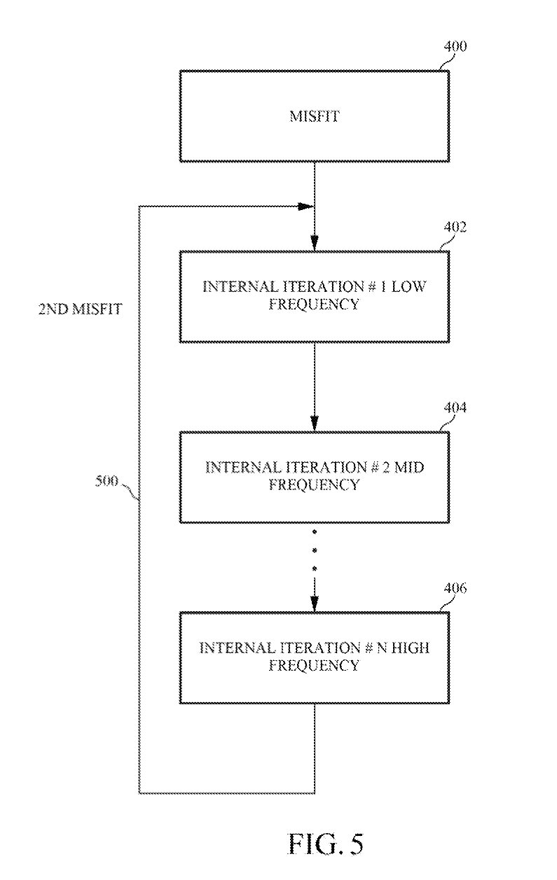

Other aspects associated with the input seismic data can optionally be addressed while performing the data regularization process described above. For example, according to one embodiment, aliasing of the input seismic data can, for example, be compensated. In, for example, marine towed-streamer acquisition, cross-line sampling is often irregular and very coarse. This makes the acquired seismic data in the cross-line direction highly spatially aliased for the high frequency content of interest. To overcome this sampling issue, along with the low-rank optimization to reduce the model parameters described above, according to an embodiment the tau-p transform uses high-cut filtered data (e.g., 10 Hz) to obtain an initial result as shown by step 402 in FIG. 4, where the initial misfit 400 is the acquired seismic data and subsequent iterations of the process of FIG. 4 use the residual data left over from the latest iteration as the misfit 400. This embodiment subsequently uses this initial, low frequency result to guide the inversion for data with higher frequencies as represented by steps 404 and 406, i.e., the low frequency result 402 can be used as a weighting function in equation (7) to constrain the inversion performed in step 404 in equations (4) and (5) and, similarly, the mid frequency result 404 can be used as a weighting function to guide the inversion performed in step 406. This process can be repeated progressively, and using as many different frequency bins of seismic data as desired, until reaching the desired higher frequency data and then generating a final tau-p model. These frequency differentiated inversion iterations are referred to herein as “internal” iterations to distinguish them from other “external” iterations which can also optionally be performed as will now be described with respect to the embodiment of FIG. 5.

The sparse inversion and low-rank optimization strategy of the foregoing embodiments naturally honors strong events and, as a result, is less responsive to weak events. It is possible to address this issue with respect to weak events by using weaker sparseness, more ps, and more iterations to better recover weak events during the inversion processing. However, this approach is inefficient and detracts from the benefits of sparse inversion. According to another embodiment, an external iteration 500 using the residual misfit can be added to the internal iterations of FIG. 4 as shown in FIG. 5 to first extract the modeled data from the input data, and then the residual (often comprising weak events) is used (in another, external iteration) to reiterate the same sparse inversions. Using this multi-step iteration strategy, embodiments can use lower-cost parameters in each external iteration, resulting in retention of weak events while maintaining a low overall cost.

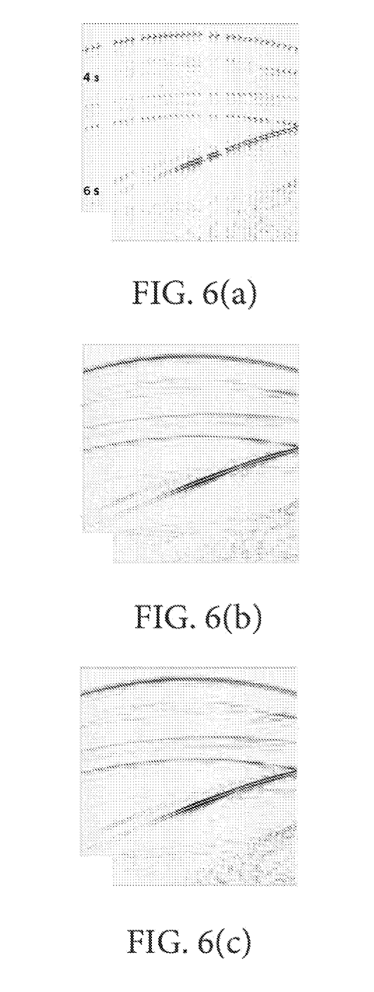

To test the efficacy of the embodiments, Applicants applied this approach to a synthetic data set modeled from the SEAM model with a regular shot and receiver spacing of 50 m×50 m. The maximum offset in both inline and crossline directions was 5 km. Seismic traces were decimated and randomly removed from the original synthetic gathers, leaving only about 18% of the original traces to be used as input 200 to the regularization process. FIGS. 6(a)-6(c) show results associated with regularization of this synthetic data using techniques in accordance with these embodiments, specifically an embodiment including features discussed above with respect to FIGS. 2-5. Specifically, FIGS. 6(a) and 6(b) show the input shot gather and the gather after data regularization, respectively. FIG. 6(c) shows the original traces before decimation and random trace removal. By comparing FIGS. 6(b) and 6(c), those skilled in the art will appreciate that most events were successfully reconstructed using a regularization technique in accordance with the foregoing embodiments.

It should be noted in the embodiments described herein that these techniques can be applied in either an “offline”, e.g., at a land-based data processing center or an “online” manner, i.e., in near real time while onboard the seismic vessel. For example, predicting a desired seismic quantity at a desired location of a desired depth can occur as the seismic data is recorded onboard the seismic vessel. In this case, it is possible for the prediction to be generated as a measure of the quality of the sampling run.

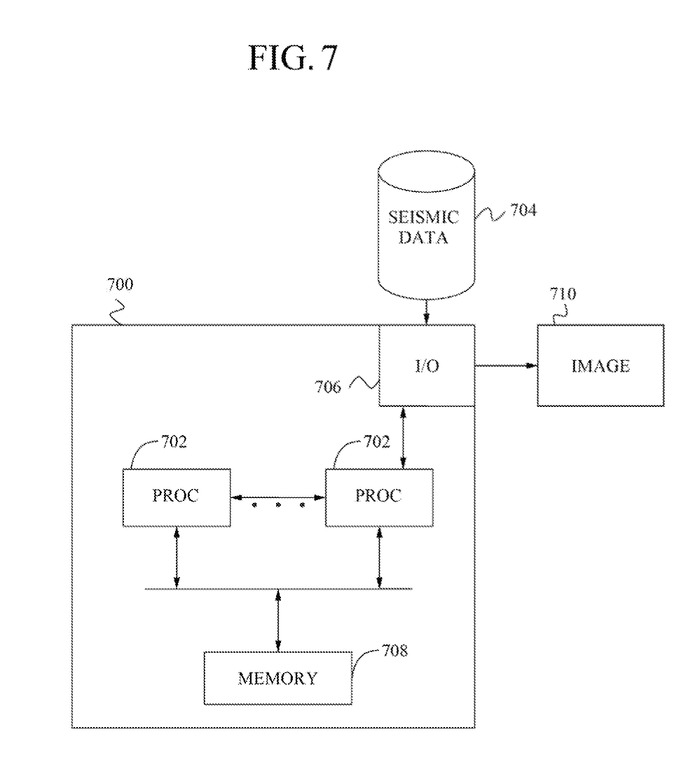

In addition to being characterized as methods, a system for processing the raw or partially processed seismic data that has been acquired by a system like that described above with respect to FIG. 1 (or other seismic acquisition systems) can take many forms such as the computing system 700 generally illustrated in FIG. 7. Therein, one or more processors 702 can receive input seismic data 704 via input/output device(s) 706. The data can be processed to regularize or interpolate the input traces as described above using a sparse tau-p inversion and stored in the memory device 708 prior to performing other processing. When the seismic data processing is complete, one or more images 710 of the subsurface associated with the seismic data can be generated either as a displayed image on a monitor, a hard copy on a printer or an electronic image stored to a removable memory device.

The disclosed exemplary embodiments provide a server node, and a method for regularizing and/or interpolating seismic trace data. It should be understood that this description is not intended to limit the invention. On the contrary, the exemplary embodiments are intended to cover alternatives, modifications and equivalents, which are included in the spirit and scope of the invention. Further, in the detailed description of the exemplary embodiments, numerous specific details are set forth in order to provide a comprehensive understanding of the invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for regularizing seismic data, said method comprising:
receiving the seismic data;
transforming the seismic data into the tau-p domain; and
regularizing the seismic data to desired positions in the tau-p domain using at least one low rank sparse inversion.

2. The method of claim 1, wherein the step of regularizing the seismic data further comprises:
performing a full rank inversion on a portion of the transformed seismic data which is lower than a predetermined frequency;
selecting p traces from an output of the full rank inversion; and
performing the low rank sparse inversion on an entire bandwidth of the seismic data based on the selected p traces.

3. The method of claim 2, wherein the step of selecting further comprises:
selecting dominant p traces which have higher energy than other p traces in the transformed seismic data.

4. The method of claim 1, wherein the at least one, low rank, sparse inversion is performed by calculating a conjugate-gradient, least square inversion.

5. The method of claim 1, wherein the step of regularizing further comprises:
sequentially performing a first sparse inversion on a first portion of the seismic data having a first frequency range, and then performing a second sparse inversion on a second portion of the seismic having a second frequency range, wherein the second frequency range is higher than the first frequency range and further wherein an output of the first sparse inversion is used to constrain the second sparse inversion.

6. The method of claim 5, further comprising:
using a residual set of seismic data output from the second inversion to re-iterate the first and second sparse inversions to retain weak events in the seismic data.

7. The method of claim 1, further comprising:
outputting regularized seismic data which includes originally acquired seismic traces as well as new seismic traces which have been interpolated and/or extrapolated from an original, irregular grid associated with the seismic data new onto a regular grid.

8. The method of claim 1, further comprising:
performing a reverse tau-p transform on the regularized seismic data.

9. The method of claim 1, further comprising:
generating an image of a subsurface associated with the received seismic data using the regularized seismic data.

10. The method of claim 9, wherein the seismic data is acquired using a marine seismic acquisition system including at least one source and a plurality of receivers, wherein the source generates waves which reflect from reflectors in layers of the subsurface and return to the plurality of receivers.

11. A computing system for regularizing seismic data, the system comprising:
an interface for receiving the seismic data; and
at least one processor connected to the interface and configured to, transform the seismic data into the tau-p domain; and
regularize the seismic data to desired positions in the tau-p domain using at least one low rank sparse inversion.

12. The system of claim 11, wherein the at least one processor is further configured to regularize the seismic data by:
performing a full rank inversion on a portion of the transformed seismic data which is lower than a predetermined frequency;
selecting p traces from an output of the full rank inversion; and
performing the low rank sparse inversion on an entire bandwidth of the seismic data based on the selected p traces.

13. The system of claim 12, wherein the at least one processor is further configured to select the p traces by selecting dominant p traces which have higher energy than other p traces in the transformed seismic data.

14. The system of claim 11, wherein the at least one processor is further configured to perform the low rank, sparse inversion by calculating a conjugate-gradient, least square inversion.

15. The system of claim 11, wherein the at least one processor is further configured to regularize the seismic data by sequentially performing a first sparse inversion on a first portion of the seismic data having a first frequency range, and then performing a second sparse inversion on a second portion of the seismic having a second frequency range, wherein the second frequency range is higher than the first frequency range and further wherein an output of the first sparse inversion is used to constrain the performance of the second sparse inversion.

16. The system of claim 15, wherein the at least one processor is further configured to use a residual set of seismic data output from the second inversion to re-iterate the first and second sparse inversions to retain weak events in the seismic data.

17. The system of claim 11, wherein the interface is further configured to output regularized seismic data which includes originally acquired seismic traces as well as new seismic traces which have been interpolated and/or extrapolated from an original, irregular grid associated with the seismic data new onto a regular grid.

18. The system of claim 11 wherein the at least one processor is further configured to perform a reverse tau-p transform on the regularized seismic data.

19. The system of claim 11, wherein the interface is further configured to generate an image of a subsurface associated with the received seismic data using the regularized seismic data.

20. The system of claim 19, wherein the seismic data is acquired using a marine seismic acquisition system including at least one source and a plurality of receivers, wherein the source generates waves which reflect from reflectors in layers of the subsurface and return to the plurality of receivers.
